(19) United States
(12) Patent Application Publication
(10) Pub. No.: US 2025/0087804 A1
(43) Pub. Date: Mar. 13, 2025

(54) DIE CAST BATTERY ENCLOSURE

(71) Applicant: STEWART & STEVENSON LLC, Houston, TX (US)

(72) Inventor: Michael WARHUS, Houston, TX (US)

(21) Appl. No.: 18/818,703

(22) Filed: Aug. 29, 2024

Related U.S. Application Data
(60) Provisional application No. 63/537,150, filed on Sep. 7, 2023.

(51) Int. Cl. H01M 50/224; H01M 10/613; H01M 10/653; H01M 10/6551; H01M 50/233; H01M 50/342

(52) U.S. Cl. CPC H01M 50/224; H01M 10/613; H01M 10/653; H01M 10/6551; H01M 50/233; H01M 50/3425; H01M 2200/20

(57) ABSTRACT

The die cast battery enclosure includes a bottom portion, the bottom portion being die cast, and an integral heat sink, the integral heat sink positioned within the bottom portion. The die cast battery enclosure further includes a seal, the seal positioned on the bottom portion, and a top portion, the top portion positioned against the seal when the die cast battery enclosure is closed. In addition, the die cast battery enclosure includes a plurality of battery cells positioned within the bottom portion.

### CROSS-REFERENCE TO RELATED APPLICATIONS

This application is a nonprovisional application which claims priority from U.S. provisional application No. 63/537,150, filed Sep. 7, 2023, which is incorporated by reference herein in its entirety.

### TECHNICAL FIELD/FIELD OF THE DISCLOSURE

The present disclosure relates generally to die cast enclosures for enclosing battery cells immersed in non-conductive cooling media.

### BACKGROUND OF THE DISCLOSURE

Batteries in storage systems may be formed into cells, cells into modules, and modules into systems. Many such storage systems include an immersion fluid for cooling and, in some cases, containment. Cells and modules may be organized into certain configurations that may help prevent thermal runaway from such causes as high temperature, puncture, external impact, external short circuit, and overcharge.

### SUMMARY

The present disclosure provides a die cast battery enclosure. The die cast battery enclosure includes a bottom portion, the bottom portion being die cast and an integral heat sink, the integral heat sink positioned within the bottom portion. The die cast battery enclosure further includes a seal, the seal positioned on the bottom portion and a top portion, the top portion positioned against the seal when the die cast battery enclosure is closed. In addition, the die cast battery enclosure includes a plurality of battery cells positioned within the bottom portion.

The present disclosure also provides for a method of manufacturing a battery module. The method includes forming a bottom portion of the die cast battery enclosure and installing battery cells within the bottom portion of the die cast battery enclosure, the bottom portion including outer walls. The method further includes filling the bottom portion of the die cast battery enclosure with a cooling media and installing a seal on the bottom portion of the die cast battery enclosure. Also, the method includes installing a cover on the seal on the bottom portion of the die cast battery enclosure.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is an isometric view of the bottom portion of a die cast battery enclosure consistent with certain embodiments of the present disclosure.

FIGS. 2a and 2b are isometric views of the bottom portion of a die cast battery enclosure consistent with certain embodiments of the present disclosure.

FIG. 3 is a diagram of steps for forming a die cast battery enclosure.

FIG. 4 is an exploded view of a die cast battery enclosure with battery cells consistent with certain embodiments of the present disclosure.

FIG. 5 is an isometric view of the bottom portion of a die cast battery enclosure consistent with certain embodiments of the present disclosure.

FIGS. 6a-6c are expanded views of the vent of a die cast battery enclosure consistent with certain embodiments of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

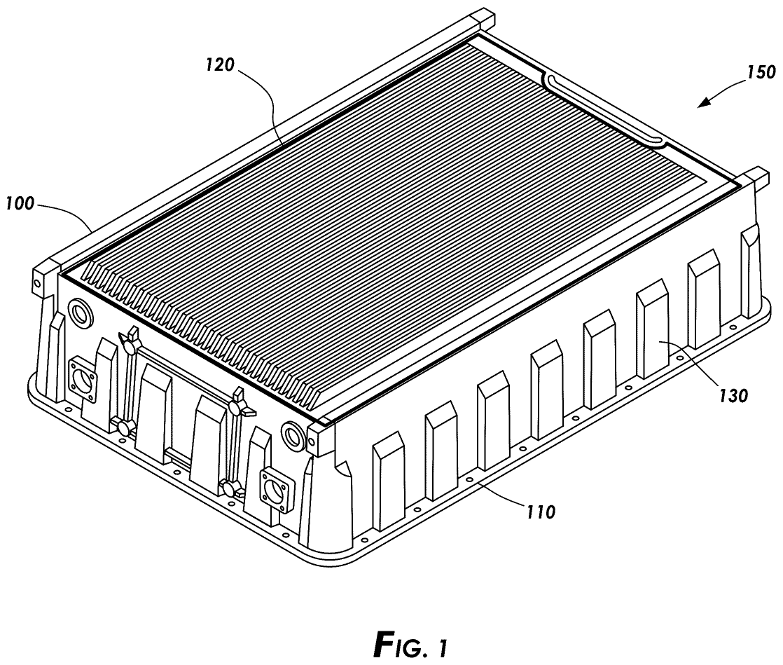

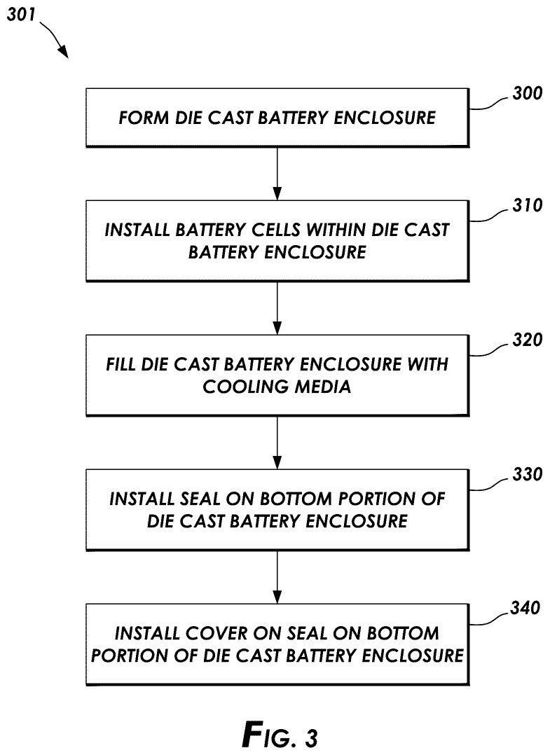

FIG. 1 depicts an embodiment of die cast battery enclosure 100. Die cast battery enclosure 100 includes bottom portion 110 and cover 120. In certain embodiments, both bottom portion 110 and cover 120 are die cast metal. In certain other embodiments, only bottom portion 110 is die cast metal. In those embodiments, die casting bottom portion 110 and cover 120 may be performed with a thin wall die casting method, in which metal is heated to a pre-defined temperature and driven into a mold to form a wall enclosure, which acts as outer walls 130 of die cast battery enclosure 100, as depicted in FIG. 3 (300). In these embodiments, outer walls 130 are less than 5 mm thick, or between 0.04 inches to 0.2 inches. In other embodiments, different die casting methods are used for outer walls 130 resulting in different wall thicknesses. These different die casting methods to form thicker outer walls 130 may be used because of battery chemistry, immersion fluid type, arrangement, application, or other factors.

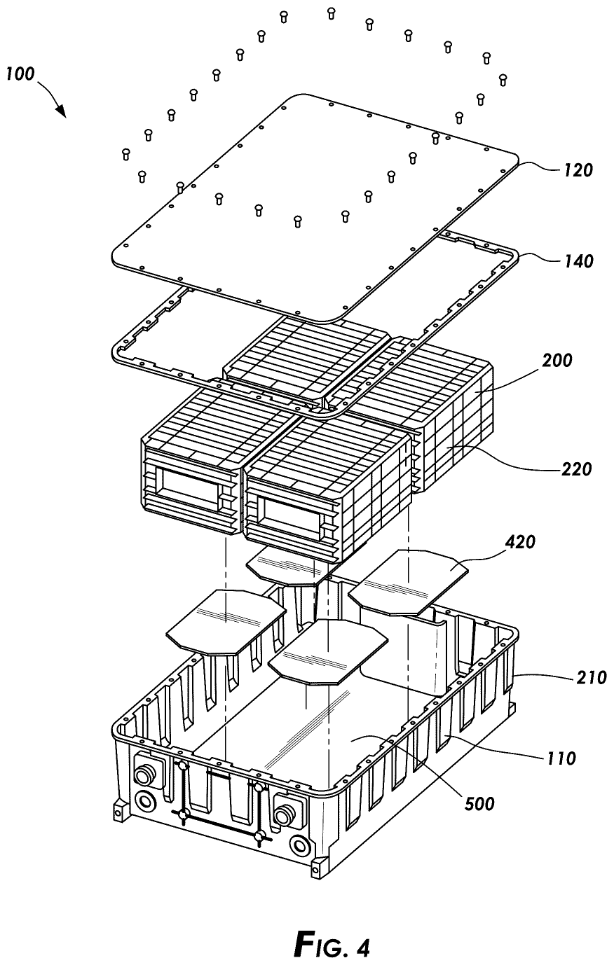

FIG. 3 depicts the steps of forming a battery module (301). Battery cells 200, power and communication electronics may be installed within die cast battery enclosure 100, specifically bottom portion 110 as shown in FIGS. 3 (310) and 4. Die cast battery enclosure 100 can be filled with a non-conductive cooling media, immersing battery cells 200 (320). Die cast battery enclosure 100 may be filled with different media, including for example and without limitation, water, mineral oil, di-electric esters, dielectric hydrocarbons, potting compounds, gels, a gas, or any fluid that enhances the movement of heat from the cells from the interior of die cast battery enclosure 100 to the exterior of die cast battery enclosure 100. Seal 140, as shown in FIG. 5, and cover 120, as shown in FIG. 1 are added to bottom portion 110 of die cast battery enclosure 100 to create sealed battery module 150, as shown in FIG. 1 that restricts the egress flow of fluid from die cast battery enclosure 100. In certain embodiments, seal 140 may also provide protection from ingress of foreign substances (such as dust, or water when submersed). These steps are show as (330) and (340) in FIG. 3

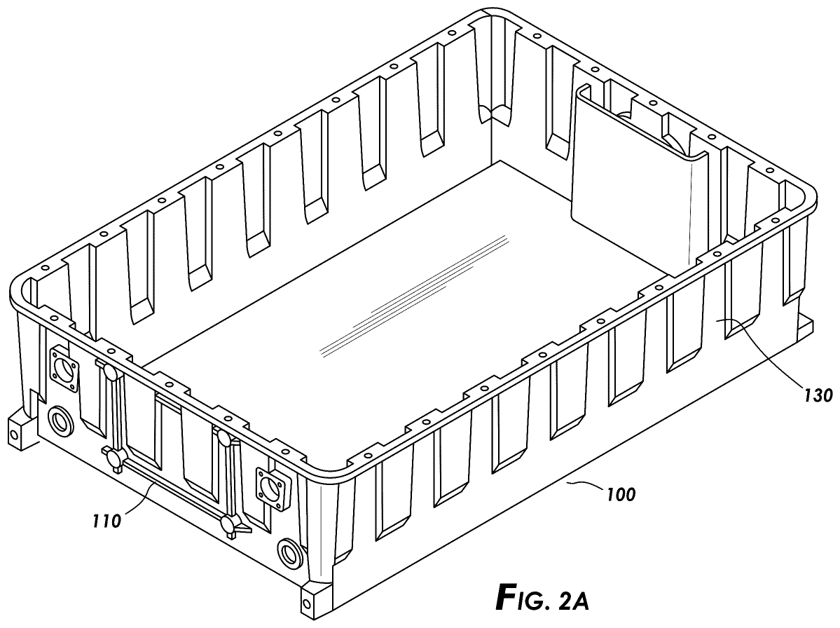

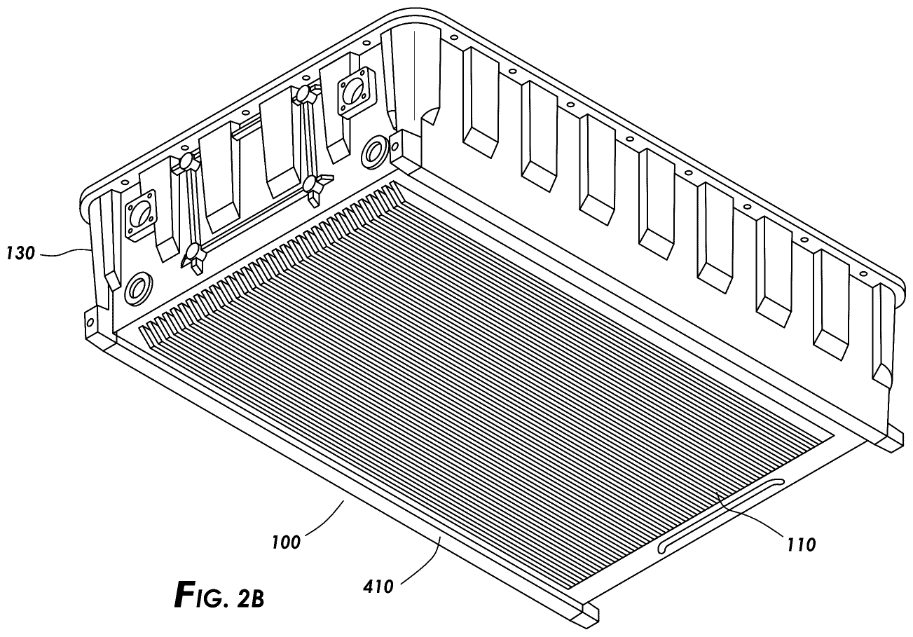

As shown in FIG. 2b die case battery module 100 includes an integral heat sink 410. Heat sink 410 has at least a portion of its surface area in contact with battery cells 200. Heat sink 410 also has a portion of its surface area in contact with the cooling media. One or more sides 210 of bottom portion 110 are in contact with heat sink 410. Thermally conductive material 420, such as thermally conductive gap pad material or a potting compound, may be included to aid in heat transfer. One or more sides 220 of battery cells 200 are surrounded by the cooling media 500. The cooling media absorbs heat output from battery cells 200, and transfers that heat to outer walls 130 of die cast battery enclosure 100.

In certain embodiments, die cast battery enclosure 100 is made from a heat conductive material including, but not limited to aluminum, magnesium, iron, titanium, copper, or any material that may be die cast.

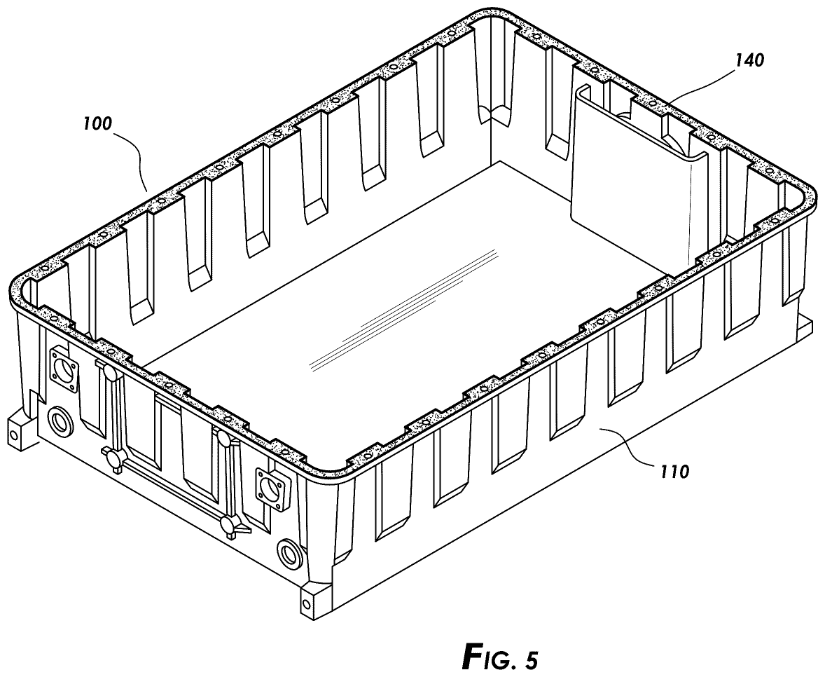

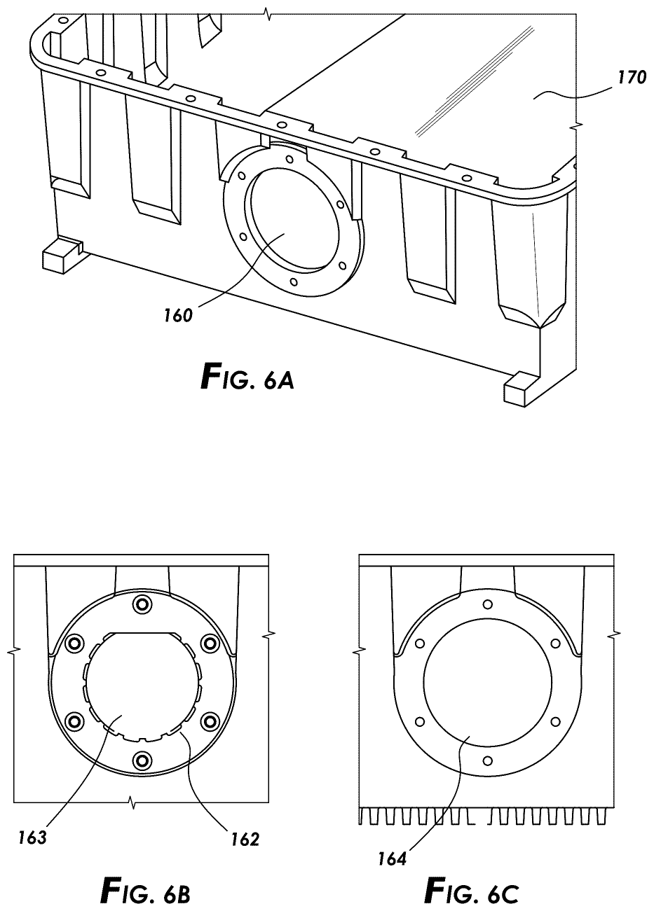

As shown in FIG. 6a, in certain embodiments, die cast battery enclosure 100 includes vent 160. Vent 160 may include burst disk 162, for example, as shown in FIG. 7b, a reverse burst disk with concave surface 163 extending into interior 170 of die cast battery enclosure 100, which allows for lower rupture pressures than a standard burst disk. Any type of burst disk or deflagration component may be used, which has been designed to open once a pressure threshold has been reached. In certain embodiments, burst disk 162 may rupture between 8 and 10 psi. In other embodiments, burst disk, 162 may rupture at a predetermined value from 1 psi to 20,000 psi. In certain embodiments, vent 160 is adapted to be compatible with the immersion fluid used.

Adjacent to burst disk 162, on interior 170 is fluid blocker 164. Fluid blocker 164 allows for the ventilation of gases and cell ejecta without the loss of the cooling media from die cast battery enclosure 100. Fluid blocker 164 serves as a secondary containment function. In certain embodiments, fluid blocker 164 may be formed as part of the die cast process. In other embodiments, fluid blocker 164 is a separate component that may be affixed to bottom portion 110 by welding or gluing. Fluid blocker 164 may be, for example, plastic or metal.

In certain embodiments, using the thin wall die cast method for bottom portion 110 of die cast battery enclosure 100, along with cover 120 and seal 140 (as shown in FIG. 5), allows for the containment of heat and management of pressure, without compromising the structural integrity of the bottom portion 110, seal 140, and cover 120. Upon rupture of burst disk 162, any harmful gases, heat, and/or ejecta are removed from die cast battery enclosure 100. The cooling media remains in the enclosure, fluid blocker 164, to aid in continuous cooling of battery cells 200 as they proceed through thermal runaway and can mitigate thermal runaway of battery cells 200 by reducing heat transfer between cells.

Die cast battery enclosure 100 may be used for battery cells 200 that allow for the type of cooling method described above. Examples of battery cells include lithium-ion varieties such as nickel manganese cobalt (NMC), lithium titanate (LTO) lithium ferrous phosphate (LFP), and solid state types of batteries each in prismatic, cylindrical, or pouch arrangements, for example.

Electrical/communication ports may be arranged in any number of ways and different numbers. The types of connectors which may be accommodated are communication connectors, terminal connectors, breakers, switches, HMI, or any connector that allows for electrical signal to travel from the exterior of the enclosure to the interior while maintaining ingress protection previously described in this disclosure.

Articles of the present disclosure improve the cooling rate of the battery cells 200 and allow for high cell C-rates. (C-rate is a measure of the rate at which a battery is charged or discharged relative to its capacity.)

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A die cast battery enclosure comprising:
a bottom portion, the bottom portion being die cast;
an integral heat sink, the integral heat sink positioned within the bottom portion;
a seal, the seal positioned on the bottom portion;
a top portion, the top portion positioned against the seal when the die cast battery enclosure is closed; and
a plurality of battery cells positioned within the bottom portion.

2. The die cast battery enclosure of claim 1 further comprising a vent, the vent positioned on a wall of the bottom portion.

3. The die cast battery enclosure of claim 2 further comprising a burst disk, the burst disk within the vent.

4. The die cast battery enclosure of claim 3 wherein the burst disk is adapted to rupture between 8 and 10 psi.

5. The die cast battery enclosure of claim 3, wherein the burst disk is a reverse burst disk with a concave surface extending into an interior of the bottom portion.

6. The die cast battery enclosure of claim 3 further comprising a fluid blocker, the fluid blocker positioned adjacent the burst disk.

7. The die cast battery enclosure of claim 1, wherein outer walls of the bottom portion are made using a thin wall die casting method.

8. The die cast battery enclosure of claim 7, wherein the outer walls are less than 5 mm thick.

9. The die cast battery enclosure of claim 1, wherein the integral heat sink has a surface area and wherein a portion of the surface area of the integral heat sink is in contact with the battery cells.

10. The die cast battery enclosure of claim 1, wherein the die cast battery enclosure is constructed from a heat conductive material.

11. The die cast battery enclosure of claim 10, wherein the heat conductive material is aluminum, magnesium, iron, titanium, or copper.

12. The die cast battery enclosure of claim 1, wherein the battery cells are nickel manganese cobalt (NMC) or lithium ferrous phosphate (LFP).

13. The die cast battery enclosure of claim 1, wherein the battery cells are in prismatic, cylindrical or pouch arrangements.

14. A method of manufacturing a battery module comprising:
forming a bottom portion of die cast battery enclosure;
installing battery cells within the bottom portion of the die cast battery enclosure, the bottom portion including outer walls;
filling the bottom portion of the die cast battery enclosure with a cooling media;
installing a seal on the bottom portion of the die cast battery enclosure; and
installing a cover on the seal on the bottom portion of the die cast battery enclosure.

15. The method of claim 14, where battery cells are nickel manganese cobalt (NMC), lithium titanate (LTO) lithium ferrous phosphate (LFP), or solid state type.

16. The method of claim 14 further comprising installing an integral heat sink prior to installing the battery cells.

17. The method of claim 16, wherein the integral heat sink comprises a thermally conductive gap pad material or a potting compound.

18. The method of claim 16 further comprising transferring heat from the heat sink to the outer walls.

19. The method of claim 14, wherein the cooling media is water, mineral oil, di-electric esters, dielectric hydrocarbons, potting compounds, gels, or a gas.

20. The method of claim 14, wherein bottom portion includes a burst disk.
